(19) United States
(12) Patent Application Publication
(10) Pub. No.: US 2007/0169374 A1
(43) Pub. Date: Jul. 26, 2007

(54) Cooling system leak detector

(75) Inventor: Brian A. Hamman, (US)

Correspondence Address: Arthur W. Fisher;Patent Dominion Partnership, LP, 6103 Twin Oaks Circle, Dallas, TX, 75240, US

(73) Assignee: QNX Cooling Systems Inc.

(21) Appl. No.: 11/336,304

(22) Filed: Jan. 23, 2006

(51) Int. Cl. F26B 19/00

(52) U.S. Cl. 34/DIG. 1; 34/89

(57) ABSTRACT

A leak or spill detector for a system utilizing coolants is presented. A number of embodiments are presented. Each embodiment includes an absorbent material disposed in the system preferably below potential areas for leaks or spills, although other locations as suited to particular application may be used. If a spill or leak occurs, the coolant is absorbed by the absorbent material leaving an indication that leakage occurred chemically or visually. In another embodiment, if a spill or leak occurs, the coolant is absorbed by the compressed absorbent material expanding its size. This expansion of size remains even if the fluid absorbed evaporates, thereby indicating a spill or leak. Detection circuitry can be added to provide a more immediate notification of a leak or spill and/or the severity of the leak or spill.

### CROSS REFERENCE TO RELATED APPLICATIONS

Reference is made to pending U.S. patent application Ser. No. 10/688,587 filed Oct. 18, 2003 for a detailed description of a cooling system and various heat transfer units and heat exchangers and their operation.

### BACKGROUND OF THE INVENTION

### Description of the Related Art

At the heart of data processing and telecommunication devices are processors and other heat-generating components which are becoming increasingly more powerful and generating increasing amounts of heat. As a result, more powerful cooling systems are required to prevent these components from thermal overload and resulting system malfunctions or slowdowns.

Traditional cooling approaches such as heat sinks and heat pipes are unable to practically keep up with this growing heat problem. Cooling systems which use a liquid or gas to cool these heat generating components are becoming increasingly needed and viable. These systems utilize heat transfer units thermally coupled to the heat generating components for absorbing or extracting heat from the heat generating components into a coolant flowing there through. The coolant, now heated is directed to a heat exchanger where heat is dissipated from the coolant, creating cooled coolant and return to the heat transfer unit to repeat the cycle.

Liquid cooling for these heat generating components is a much more viable approach to this heat problem. A typical liquid cooling system employs one or more heat transfer units thermally coupled to the heat generating components for absorbing heat from the components into the liquid coolant and a heat exchanger which dissipates heat from the coolant and returns cooled liquid to the heat transfer units.

Although most liquid cooling systems are designed to minimize the possibility of a leak or a spill, there is always the potential for such a spill or leak caused by damage in shipment, unauthorized tampering with the system by the user or others, a faulty seal, excess vibration, etc. To avoid damage to the electronic system or failure of the cooling system, it desirable to detect any such leak or spillage.

Thus, there is a need in the art for a method and apparatus for detecting leaks or spills of fluid in electronic systems. There is a further need in the art to provide immediate notice of a leak or spill. There is a further need in the art to retain leaked or spilled fluid. There is also a need in the art to slow down or shut down the electronic system in the event of a serious spill or leak.

### SUMMARY OF THE INVENTION

A method and apparatus for detecting and absorbing leaks or spills in electronic systems comprising an absorbent material which absorbs fluid or coolant spilled or leaked and provides an indication of the leak or spill by expanding its size and remaining expanded, even if the fluid spilled or leaked evaporates.

A method and apparatus for detecting and absorbing leaks or spills in electronic systems comprising a compressed absorbent material which absorbs fluid spilled or leaked and indicates a leak or spill by expanding its size and remaining expanded, even if the fluid spilled or leaked evaporates.

A method and apparatus for detecting and absorbing leaks or spills in electronic systems comprising a absorbent material having a dye or other chemical disposed therein and wherein leaked or spilled coolant reacts with or displaces the dye or chemical leaving an indication of such leak or spill, even if the spilled or leaked coolant evaporates.

A method and apparatus for detecting and absorbing leaks or spills in electronic systems comprising an absorbent material which absorbs fluid spilled or leaked and provides an indication of the leak or spill wherein one or more sides of the absorbent material are generally impermeable to fluid flow to retain fluid or coolant spilled or leaked.

A method and apparatus for detecting and absorbing leaks or spills in electronic systems comprising an absorbent material which absorbs fluid spilled or leaked and provides an indication of the leak or spill wherein one or more sides of the absorbent material are made generally impermeable to fluid flow by disposing the absorbent material in a housing with an open or partially open top.

A method and apparatus for detecting and absorbing leaks or spills in an electronic system having a cooling system with a coolant for cooling heat generating components in the electronic system comprising an absorbent material which absorbs fluid spilled or leaked and provides an indication of the leak or spill.

A method and apparatus for detecting and absorbing leaks or spills in electronic systems comprising an absorbent material which absorbs fluid or coolant spilled or leaked and provides an indication of the leak or spill and including a plurality of sensors responsive to the presence of coolant in the absorbent material and a sensing device coupled to the sensors for providing an indication to a system operator or user of the presence of coolant in the absorbent material.

A method and apparatus for detecting and absorbing leaks or spills in electronic systems comprising an absorbent material which absorbs fluid spilled or leaked and provides an indication of the leak or spill and including a plurality of sensors responsive to spills or leaks of coolant into the absorbent material and a sensing device coupled to the sensors for providing an indication to a system operator or user of the leak or spill wherein the sensors are electrical conductors through which current will flow in response to the presence of coolant in the absorbent material.

### BRIEF DESCRIPTION OF THE DRAWINGS

FIG. 1 is a three-dimensional view of a leak detecting mat.

FIG. 2 is a three-dimensional view of a leak detecting mat with leak detecting circuitry.

FIG. 3 is a three-dimensional view of a leak detecting mat disposed in a container or compartment.

### DETAILED DESCRIPTION

While the making and using of various embodiments of the present invention are discussed in detail below, it should be appreciated that the present invention provides many applicable inventive concepts, which can be embodied in a wide variety of specific contexts. The specific embodiments discussed herein are merely illustrative of specific ways to make and use the invention and do not limit the scope of the invention.

It should be understood that the principles and applications disclosed herein can be applied in a wide range of data processing systems, telecommunication systems and other systems. Heat produced by a heat generating component such as a microprocessor in a data processing system is transferred to a coolant in a heat transfer unit and dissipated in the cooling system. Liquid cooling solves performance and reliability problems associated with heating of various heat generating components in electronic systems.

The present invention may be utilized in a number of computing, communications, and personal convenience applications. For example, the present invention could be implemented in a variety of servers, workstations, exchanges, networks, controllers, digital switches, routers, personal computers which are portable or stationary, cell phones, and personal digital assistants (PDAs) and many others.

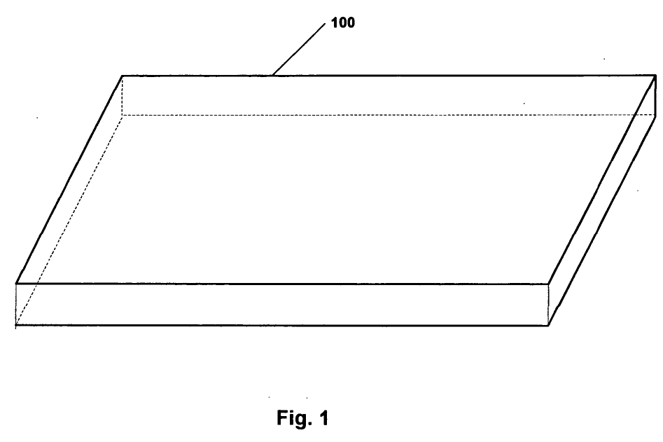

Referring now to FIG. 1, the leak detector 100 is shown in its simplest form. The detector comprises a thin sheet of absorbent material. The detector 100 is sized to fit at the bottom of a system housing such as a computer system which has a cooling system or otherwise uses coolants or fluids. Preferably, it should be long and wide enough to be disposed directly below any areas in the system where a leak or spill could occur, although this is not required.

The leak detector may be made of compressed celluloid sponge, desiccant or any other compressed or non-compressed absorbent material. When utilizing a compressed absorbent material, if a coolant spill or leak occurs, the fluid is absorbed by the detector 100 and the detector expands in size whereby it has absorbed fluid. The fluid is kept safely away from components which could be damaged or otherwise affected. Moreover, the detector 100 will retain its expanded size, even if evaporation of the fluid occurs, thereby indicating that leak has occurred. The detector 100 will detect even minute amounts of fluid spilled or leaked.

Other leak detection methods can be used especially on an embodiment utilizing non-compressed absorbent material. The other methods can include dyes or other chemicals which react to or are displaced by the presence of the coolant in the absorbent material and produce an indication, such as a color change, for example, that liquid was absorbed by the mat. Additionally mechanical devices may be used alone or in combination with any of the above methods, depending on the particular application, to provide the indication that coolant or fluid has been spilled or leaked.

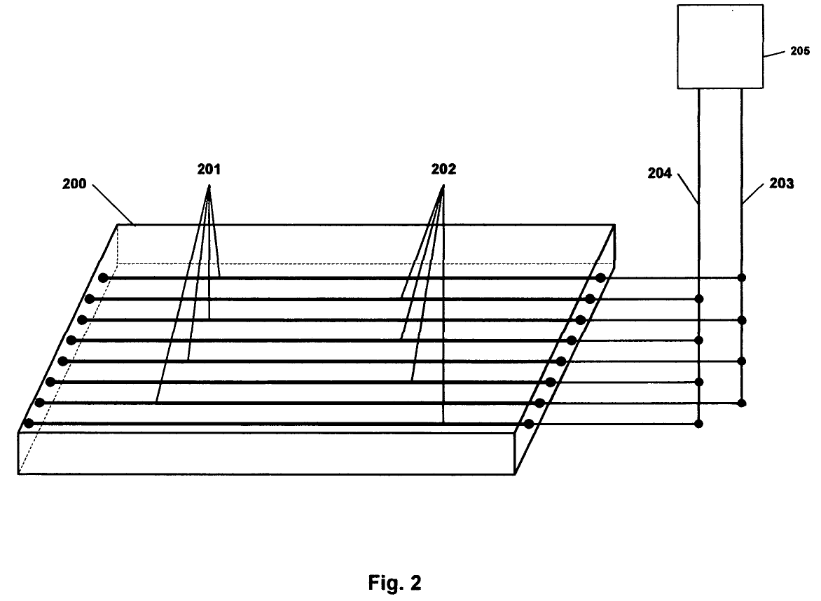

Referring now to FIG. 2, a “smart” version of the leak detector 200 is depicted. Again the leak detector 200 is comprised of an absorbent material. The leak detector 200 also includes a plurality of sensors such as electrical conductors 201 and 202. The electrical conductors 201 and 202 may be comprised of any number of materials and shapes. For the purposes of FIG. 2, very thin, copper wire is depicted. Within the detector 200, the electrical conductors have no insulation. It will be appreciated that the present invention encompasses other forms of “smart” sensors in addition to electrical conductors.

In FIG. 2, electrical conductors 201 are interleaved with electrical conductors 202 within the detector 200. Electrical conductors 201 are all electrically coupled to one electrical conductor 203 of an electrical detection unit 205 while electrical conductors 202 are all coupled to another electrical conductor 204 of the electrical detection unit 205.

In operation, if a coolant leak or spill occurs, it is absorbed by one or more parts of the detector 200. When the amount of coolant spilled or leaked reaches a sufficient level, it will act as a conductor of electricity between one or more interleaved pairs of an electrical conductor 201 and electrical conductor 202. A small amount of current will now flow from electrical conductor 203 to electrical conductor 204. The detector circuitry 205 detects this flow of current. Electronic detection by other means is within the scope of this invention, such as chemical, thermal, or other detection systems that would be obvious to one skilled in the art.

The system may be configured to respond to this leakage detection in any number of ways. For example, an indicator light may be illuminated or and audible indication may be generated or both. This indication could be configured to work even when the system is turned off. If the system has a monitor, a warning notice could also be generated. The system could also be configured to turn itself off or safely shut down or, if the system has a fluid cooling system, to shut that down as well. All of the above types of indications or reactions may also be rated and may be performed by a processor executing suitable software code connected to or forming part of the detector circuitry 205 of the leak detector 200. The processor may comprise a main processor of the system, device or apparatus containing the leak detection system of the invention . . . As more leakage occurs and the severity of the spill or leak increases, any combination of actions could be programmed to occur to best deal with a particular situation which would be obvious to one skilled in the art. For example, depending on the severity of the leakage a different color of illumination or a different audible alert or any combination of actions could be programmed to occur. Similarly, other system reactions to the spill or leak may by differentiated by the seriousness of the leak or spill.

It will be further understood that the sensitivity of electrical detection of a spill or leak into the detector 200 may be adjusted by any number of ways. For example, the spacing between each electrical conductor 201 and electrical conductor 202 may be diminished, or additional layers of electrical conductors 201 and 202 may be added, or a single mesh or a plurality of meshes of electrical conductors 201 and 202 may be used, etc.

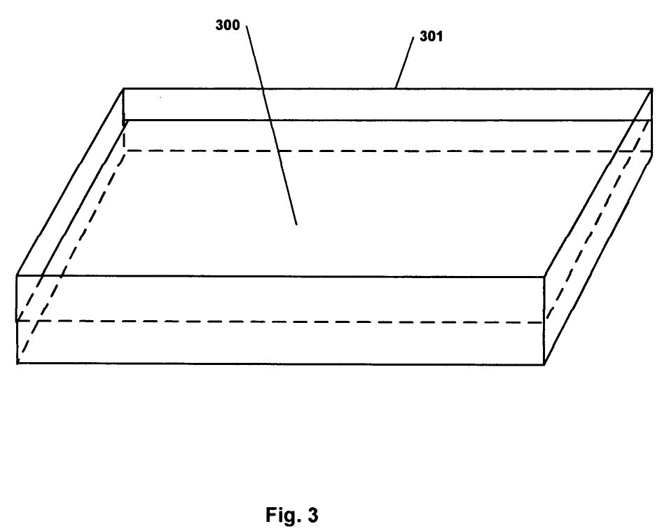

Referring now to FIG. 3, another embodiment of the present invention is depicted. The leak detector 300 is disposed within a container 301 with an open top surface. Container 301 serves to waterproof or make the leak detector 300 generally impermeable to the flow of fluid or coolant so that spilled or leaked fluid is retained and does not escape from the detector 300 to cause damage or problems of any kind. This embodiment would form an open top vessel containing absorbent material. Alternatively, suitable surfaces of the absorbent material may be coated or somehow treated with a fluid impermeable material. This may comprise a surface treatment such as the application of a plastics material to such surfaces or a treatment whereby the waterproofing material is absorbed a small distance into the fabric of the absorbent material to thereby form a waterproof barrier. Further alternately, the waterproofing can be completely omitted so that the absorbent mat would be able to absorb any coolant that comes into contact with any surface of the mat.

It will be understood that alternative forms of waterproofing the detector 300 may be used and that the detector 300 may be deployed with or without the electrical detection/indication apparatus described for FIG. 2.

Thus, the present invention has been described herein with reference to particular embodiments for particular applications. Those having ordinary skill in the art and access to the present teachings will recognize additional modifications, applications, and embodiments within the scope thereof.

It is, therefore, intended by the appended claims to cover any and all such applications, modifications, and embodiments within the scope of the present invention.

What is claimed is:

1. A device for detecting and absorbing coolant spilled or leaked in an electronic system comprising:
an absorbent material disposed in the electronic system for absorbing leaks or spills of coolant; and
wherein the material absorbs coolant leaked or spilled and provides an indication of the leak or spill.

2. The device as set forth in claim 1 wherein the absorbent material is compressed and wherein the indication of the leak or spill is an expansion of the absorbent material, and such expansion remains even if the coolant spilled or leaked evaporates.

3. The device as set forth in claim 1 wherein the absorbent material contains a chemical which is displaced by or reacts with the spilled or leaked coolant, the displacement or reaction providing an indication of a spill or leak.

4. The device as set forth in claim 1 wherein the electronic system further includes a cooling system having a coolant for cooling heat-generating components in the electronic system.

5. The device as set forth in claim 1 wherein the absorbent material is generally impermeable to fluid flow on one or more sides.

6. The device as set forth in claim 5 wherein the impermeability of the one or more sides of the absorbent material is comprised of a housing with an open or partially open top and in which the absorbent material is disposed.

7. The device as set forth in claim 1 further comprising:
a plurality of sensors disposed in the absorbent material and responsive to the presence of coolant in the absorbed material;
a sensing device coupled to the sensors; and
wherein the sensing device detects leakage or spillage when coolant is present in the absorbent material.

8. The device as set forth in claim 7 wherein the sensors are electrical conductors and wherein spilled or leaked coolant into the absorbent material causes an electrical current to flow between one or more of the electrical conductors, the sensing device detecting the flow of current through the conductors.

9. The device as set forth in claim 5 further comprising:
a plurality of sensors disposed through the absorbent material and responsive to the presence of coolant in the absorbed material;
a sensing device coupled to the sensors; and
wherein the sensing device detects leakage or spillage when coolant is present in the absorbent material.

10. The device as set forth in claim 9 wherein the sensors are electrical conductors and wherein spilled or leaked coolant into the absorbent material causes an electrical current to flow between one or more of the electrical conductors, the sensing device detecting the flow of current through the conductors.

11. The device as set forth in claim 7 further comprising:
notification means coupled to the sensing device for enabling indicators in the electronic system in response to the sensing device detecting the presence of coolant in the absorbent material.

12. The device as set forth in claim 9 further comprising:
notification means coupled to the sensing device for enabling indicators in the electronic system in response to the sensing device detecting the presence of coolant in the absorbent material.

13. A data processing system having the device of claim 1.

14. A telecommunications system having the device of claim 1.

15. An optical device having the device of claim 1.

16. A device having one or more processors and having the device of claim 1.

17. A method of absorbing and detecting coolant spilled or leaked in an electronic system comprising the steps of:
absorbing the coolant leaked or spilled in absorbent material; and
detecting the coolant spilled or leaked and providing and indication of such leak or spill in the absorbent material.

18. The method of claim 17 wherein the absorbent material is compressed and the indication of coolant leakage or spillage is provided by an expansion of the compressed absorbent material, such expansion remaining even if the spilled or leaked coolant evaporates.

19. The method of claim 17 wherein the absorbent material includes one or more dyes or other chemicals which react with or are displaced by coolant in the absorbent material and provide an indication of such leak or spill, even if the spilled or leaked coolant evaporates.

20. The method of claim 17 further comprising the steps of:
detecting the presence of coolant in the absorbent material by one or more of a plurality of sensors disposed in the absorbent material; and
providing an indication to a system operator or user in response to the detection of coolant in the absorbent material by the sensors.
